(19) United States
(12) Patent Application Publication
(10) Pub. No.: US 2006/0268924 A1
(43) Pub. Date: Nov. 30, 2006

(54) Method and apparatus for dynamically adjusting a deferred transmission level and a transmission power level in a wireless communication system

(75) Inventors: Paul Marinier, Brossard (CA); Arty Chandra, Manhasset Hills, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/393,432

(22) Filed: Mar. 30, 2006

Related U.S. Application Data
(63) Continuation-in-part of application No. 11/209,078, filed on Aug. 22, 2005.
(60) Provisional application No. 60/667,446, filed on Apr. 1, 2005.
(60) Provisional application No. 60/678,645, filed on May 6, 2005.
(60) Provisional application No. 60/678,645, filed on May 6, 2005.

(51) Int. Cl. H04L 12/413

(52) U.S. Cl. 370/445; 455/522

(57) ABSTRACT

The present invention is a method and apparatus for dynamically adjusting deferred transmission level and a transmission power level in a wireless communication system implementing carrier sense multiple access/collision avoidance (CSMA/CA) mechanism. A plurality of transmission power levels and associated metrics are defined for an access point (AP) and a wireless transmit/receive unit (WTRU). If a packet originated from a neighboring basic service set (BSS) is received, the metric is updated for each of the transmission power levels. The metric is increased if it is determined that transmission at a particular transmission power level associated to the metric would cause a partial defer to a sender and a receiver of the packet. The AP and the WTRU selects a transmission power level having a smallest metric. The AP and WTRU may also adjust the deferred transmission level in accordance with measurement results.

### CROSS REFERENCE TO RELATED APPLICATION

This application claims the benefit of U.S. provisional application No. 60/678,645, filed May 6, 2005 and U.S. provisional application No. 60/667,446, filed Apr. 1, 2005 and is a continuation-in-part of U.S. patent application Ser. No. 11/209,078 filed Aug. 22, 2005, which claims priority from U.S. provisional application No. 60/678,645, filed May 6, 2005. Applications 60/678,645, 60/667,446, and Ser. No. 11/209,078 are hereby incorporated by reference as if fully set forth.

### FIELD OF INVENTION

The present invention is related to wireless communication systems. More particularly, the present invention is a method and apparatus for dynamically adjusting a deferred transmission level and a transmission power level in a wireless communication system implementing a carrier sense multiple access/collision avoidance (CSMA/CA) mechanism.

### BACKGROUND

In wireless local area networks (WLANs) implementing a CSMA/CA mechanism, access points (APs) and wireless transmit/receive units (WTRUs) monitor the transmission medium before transmitting data. If it is detected that the medium is busy, APs and WTRUs defer transmission. The APs and WTRUs detect that the medium is busy if they receive a signal level greater than a certain threshold, (i.e., energy detect threshold), which is called the “deferred transmission level.” As more APs are deployed, transmissions from APs will increasingly interfere with each other, hence, causing deferred transmissions from on-going sessions in other co-channel APs.

It is important that the deferred transmission level be set properly. If it is set too low, the APs and WTRUs may unnecessarily defer transmission to other APs and WTRUs. If it is set too high, many collisions may occur since the APs and WTRUs would transmit data even though the medium is already busy. Therefore, it is desirable to find a scheme for properly setting the deferred transmission level in WTRUs and APs.

An extended service set (ESS) comprises a set of APs linked together by a distribution system (DS). A WTRU present in the area covered by an AP can associate to the AP and exchange data with another device through a wireless connection to the AP. More than one WTRU can be associated to the AP at a given time. WTRUs along with the AP to which the WTRUs are associated are called a basic service set (BSS). The AP is said to be serving the BSS.

In a CSMA/CA scheme, only the AP or one of the WTRUs is meant to transmit at a given time within a given BSS. An AP or WTRU, (hereinafter collectively “device”), can start transmitting a packet after having sensed the wireless medium idle for a certain period of time. The device uses its Clear Channel Assessment (CCA) function to determine whether or not the wireless medium is idle at a particular time.

The CCA function is also used in reception of a packet sent by another device. Following a notification by the CCA function that the wireless medium is becoming busy, an idle device (not already transmitting or receiving) triggers a procedure for reception of a packet. If a header of a packet is successfully detected, the device proceeds with the reception of the remaining of the packet. From that point until the end of reception of the packet, the device is generally unable to successfully receive any other arriving packet. In addition, if the other packet is received at a power level high enough to create significant interference to the currently receiving packet, the reception of the currently receiving packet will also be unsuccessful.

A packet received by a device could be destined to another device. This is determined by looking up the destination address of the packet in its MAC header. In case the destination address of the packet does not match the address of the receiving device, the receiving device may simply discard the packet.

The CCA function determines that the wireless medium is busy at least when a signal from another device operating in the same channel is received at a level higher than a deferred transmission level. With certain CCA modes, the wireless medium may be determined to be busy under certain conditions. The CCA function determines that the wireless medium is busy even when the source of the signal is from outside the BSS to which the device belongs, as long as it is received at a level above the deferred transmission level. This means that a device cannot start transmitting a packet when the CCA function indicates that the medium is busy due to a transmission from a device in a neighboring BSS and the device cannot start receiving a packet sent by a device in its own BSS, while it is receiving a packet sent by a device in a neighboring BSS. Therefore, the presence of another co-channel BSS in the neighborhood may reduce the capacity of the BSS.

When a device in a given BSS transmits at a certain power level, different situations may arise in a neighboring co-channel BSS depending on path losses to the devices in the neighboring co-channel BSS. Referring to FIG. 1, examples of such situations are explained.

If signals sent by a device, such as AP 102a, in one BSS is received at both a WTRU and an AP, such as WTRU 104c and AP 102b, in a neighboring BSS at a level sufficiently high to trigger a “wireless medium busy” indication, both WTRU 104c and AP 102b will refrain from transmitting to each other during reception of the packet sent from AP 102a and an additional backoff period. This situation is referred to as “full defer”.

If signals transmitted from a device, (such as AP 102a), is received at a level sufficiently high to trigger a “wireless medium busy” indication at an AP, (such as AP 102b), but not at a WTRU, (such as WTRU 104c), or vice versa, this situation is referred to as “partial defer”. In partial defer situation, there is a high probability of collision when WTRU 104c transmits a packet to AP 102b, because WTRU 104c is unaware of any transmission from AP 102a that AP 102b is receiving. Conversely, if a “wireless medium busy” indication is triggered at WTRU 104c but not at AP 102b, there is a high probability of collision when AP 102b transmits a packet to WTRU 104c.

If signals transmitted from a device, (such as AP 102a), is not received at a level sufficiently high to trigger a “wireless medium busy” at either an AP or a WTRU, (such as AP 102b and WTRU 104c), both AP 102b and WTRU 104c may transmit to each other without hindrance from AP 102a. This situation is referred to as “no defer”.

From the point-of-view of the capacity achievable in a neighboring BSS 120, the best situation is no defer, provided that the interference generated by devices in BSS 110 (and its associated devices) stays low compared to the desired signals received in the neighboring BSS 120. When this scenario is realized, the devices within the neighboring BSS 120 can transmit and receive packets even while the device in the BSS 110 transmits and a substantial capacity gain (over the full defer scenario) can be achieved.

If a no defer situation cannot be realized, a full defer situation is generally preferable to a partial defer situation, because partial defer may result in a large number of collisions, and under the IEEE 802.11 standard, collisions incur increase of the size of its contention window, which increases its medium access delay.

For particular locations of the devices, each of the above situations can be realized depending on the transmission power of the devices. In the foregoing example, the full defer situation may occur for any transmission power level of AP 102a above a certain threshold (P_{f}), such that a wireless medium busy indication is triggered at both AP 102b and WTRU 104c. A no defer situation may occur for any transmission power level of A P 102a below another threshold (Pₙ), such that a wireless medium busy is not triggered at either AP 102b or WTRU 104c. The partial defer situation may occur for any transmission power level of AP 102a in between the two thresholds (P_{f} and Pₙ).

In prior art, a transmission power level of the device is set to a maximum value of the transmitter or a lower value based on a wanted coverage area of the BSS, if the device in an AP. There is no consideration to the possibility that the resulting power level may be detrimental to the capacity in neighboring BSSs. Such a possibility is likely because, as explained above, by operating within a certain range of transmission power a device can realize the partial defer situation in neighboring BSSs that are damaging to their performance.

Therefore, it is desirable to have a method for autonomously adjusting a transmission power level to a value that maximizes the capacity in other BSSs, subject to the constraint that the capacity in the device's own BSS is not adversely impacted by an excessive reduction of its transmission power.

### SUMMARY

The present invention is a method and apparatus for dynamically adjusting deferred transmission level and a transmission power level in a wireless communication system implementing CSMA/CA mechanism. A plurality of transmission power levels and associated metrics are defined for an AP and a WTRU. If a packet originated from a neighboring BSS is received, the metric is updated for each of the transmission power levels. The metric is increased if it is determined that transmission at a particular transmission power level associated to the metric would cause a partial defer to a sender and a receiver of the packet. The AP and the WTRU selects a transmission power level having a smallest metric.

The AP and the WTRU also measure the signal strength from an associated WTRU and AP and neighboring APs, and adjust the deferred transmission level in accordance with the measurement results. If the energy level of the signals transmitted from the associated AP or WTRU is higher than energy level of signals transmitted from neighboring APs by a predetermined threshold, the AP and WTRU increase the deferred transmission level. Otherwise, the AP and WTRU may maintain the current deferred transmission level or decrease the deferred transmission level.

### BRIEF DESCRIPTION OF THE DRAWINGS

FIG. 1 is a block diagram of an infrastructure mode network implementing a method for dynamically adjusting the deferred transmission level in accordance with the present invention.

FIG. 2 is a block diagram of an ad hoc network implementing a method for dynamically adjusting the deferred transmission level in accordance with the present invention.

FIG. 3 is a flow diagram of a process for dynamically adjusting the deferred transmission level in accordance with the present invention.

FIG. 4 is a block diagram of an apparatus for dynamically adjusting the deferred transmission level in accordance with the present invention.

FIG. 5 is a diagram of a medium access control (MAC) frame format.

FIG. 6 is a flow diagram of a process for controlling transmission power in accordance with the present invention.

FIG. 7 is a flow diagram of a detailed process for updating a metric in the process of FIG. 6.

### DETAILED DESCRIPTION OF THE PREFERRED EMBODIMENTS

Hereafter, the terminology “WTRU” includes but is not limited to a user equipment, a station (STA), a fixed or mobile subscriber unit, a pager, or any other type of device capable of operating in a wireless environment. When referred to hereafter, the terminology “AP” includes but is not limited to a Node-B, a base station, a site controller or any other type of interfacing device in a wireless environment.

The features of the present invention may be incorporated into an integrated circuit (IC) or be configured in a circuit comprising a multitude of interconnecting components.

The present invention is applicable to any wireless communication system implementing a CSMA/CA or similar mechanism such as an IEEE 802.11-based WLAN including IEEE 802.11v. The WLAN may be an infrastructure network, an ad hoc network or a mesh network.

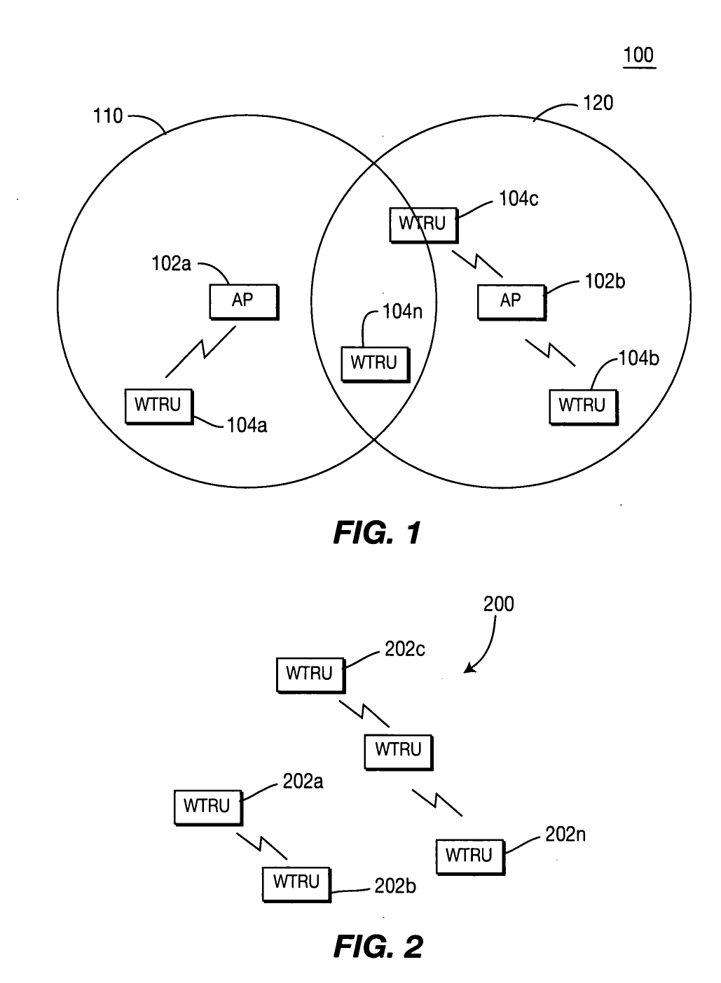

FIG. 1 is a block diagram of an infrastructure mode WLAN 100 implementing a method for dynamically adjusting the deferred transmission level in accordance with the present invention. The WLAN 100 comprises a plurality of APs 102a, 102b and WTRUs 104a-104n. For example, WTRU 104a is currently associated with AP 102a. APs 102a, 102b and WTRUs 104a-104n implement a CSMA/CA (or similar) mechanism in order to access the medium. Two BSSs 110, 120 are depicted in FIG. 1 as an example. It should be noted that any number of BSSs may be deployed and the coverage of the BSSs may overlap or one of them may fall into the other and any variances are possible.

FIG. 4 is a block diagram of an apparatus, (AP or WTRU), 400 for dynamically adjusting the deferred transmission level and transmission power level in accordance with the present invention. The apparatus 400 comprises a measurement unit 402 and a controller 404. The apparatus 400 may be included in any communication entity, such as an AP or a WTRU. The measurement unit 402, periodically or non-periodically, measures the level of signals in the medium being monitored by the controller 404. The controller 404 then sets a deferred transmission level based on the measurement results, which will be described in detail hereinafter.

A measurement unit 402 within each AP 102a, 102b or WTRU 104a-104n monitors the medium and each associated controller 404 within each AP 102a, 102b or WTRU 104a-104n compares the detected energy level to a deferred transmission level before transmitting data. In accordance with the present invention, the deferred transmission level is dynamically adjusted based on the measured signal strength from the associated AP and/or WTRUs and/or interference level.

The operator of the WLAN 100 can base the deferred transmission levels of the APs 102a-102b and WTRUs 104a-104n on the signal strength measurement, the interference level or any other type of factor, such as the levels set by the operator of neighboring APs.

For example, AP 102a measures the energy level of signals transmitted from the associated WTRU 104a and neighboring APs 102b, periodically or non-periodically. The WTRU 104a also measures the energy level of signals transmitted from the associated AP 102a and neighboring APs 102b, periodically or non-periodically. The AP 102a and WTRU 104a then individually adjust their deferred transmission level based on the measurement results. If the energy level of the signals transmitted from the associated AP 102a and WTRU 104a is higher than energy level of signals transmitted from neighboring APs 102b by a predetermined threshold, the AP 102a and WTRU 104a increase the deferred transmission level. If the energy level of the signals transmitted from the associated AP 102a and WTRU 104a is not higher than energy level of signals transmitted from neighboring APs 102b by a predetermined threshold, the AP 102a and WTRU 104a may maintain the current deferred transmission level, or may decrease the deferred transmission level.

Alternatively, the WTRU 104a may report the measurement results to the associated AP 102a instead of adjusting the deferred transmission level by itself. In this scheme, after measuring the signal strength from the associated AP 102a and neighboring APs 102b, the WTRU 104a reports the measurement results to the associated AP 102a. The associated AP 102a then adjusts the deferred transmission level and sends the deferred transmission level information to the WTRU 104a, so that it may, in turn, adjust its own transmission level.

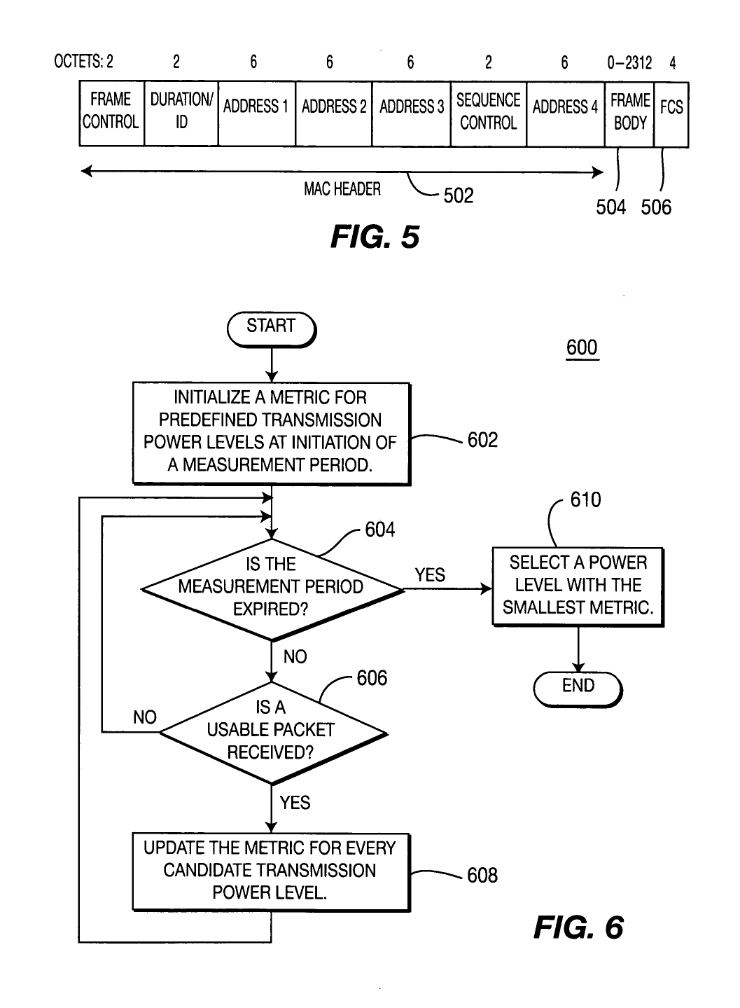

The deferred transmission level information may be sent in any frame, such as a beacon frame, a clear-to-send (CTS) frame, a request-to-send (RTS) frame, a data frame, an acknowledgement (ACK) frame, or in an individual control frame specifically designated for this purpose. For example, FIG. 5 shows a MAC frame format 500. The MAC frame 500 includes a MAC header 502, a frame body 504 and a frame check sequence (FCS) field 506. The deferred transmission level information may be included in any of the aforementioned fields.

A beacon frame is a type of management frame which enables WTRUs to establish and maintain communications in an orderly fashion. The beacon frame includes a header, a frame body and a cyclic redundancy check (CRC) field. The beacon frame body includes, among other things, information regarding a beacon interval, a timestamp, a service set identifier (SSID), supported rates, parameter sets, capability and traffic indication map (TIM). The deferred transmission level information may be included as one of the information elements in the beacon frame.

RTS and CTS frames are optionally transmitted frames to reduce frame collisions when hidden WTRUs have associations with the same AP. A WTRU and an AP exchange an RTS frame and a CTS frame in a two-way handshake method before sending a data frame. The deferred transmission level information may be included in the RTS or CTS frame.

An ACK frame is sent after successful receipt of a data frame as a part of an error checking process. The deferred transmission level information may be included in the ACK frame or the data frame.

It should be noted that the foregoing list of frames are provided as an example and any other type of frames may be utilized for transmission of the deferred transmission level information.

FIG. 2 is a block diagram of an ad hoc network 200 implementing the method for dynamically adjusting the deferred transmission level in accordance with the present invention. The ad hoc network 200 comprises a plurality of WTRUs 202a-202n directly communicating each other. Each WTRU 202a-202n measures the signal strength from a connected WTRU and other neighboring WTRUs. For example, assume that WTRU 202a is currently connected to WTRU 202b. If the energy level of signals transmitted from the connected WTRU 202b is higher than energy level of signals transmitted from neighboring WTRUs 202c-202n by a predetermined threshold, the WTRU 202a increases the deferred transmission level. If the energy level of the signals transmitted from the connected WTRU 202b is not higher than energy level of signals transmitted from neighboring WTRUs 202c-202n by a predetermined threshold, the WTRU 202a may maintain the current deferred transmission level or may decrease the deferred transmission level. Although not shown herein, the present invention may also be implemented in a mesh network or any other type of wireless or wired network using a CSMA/CA mechanism.

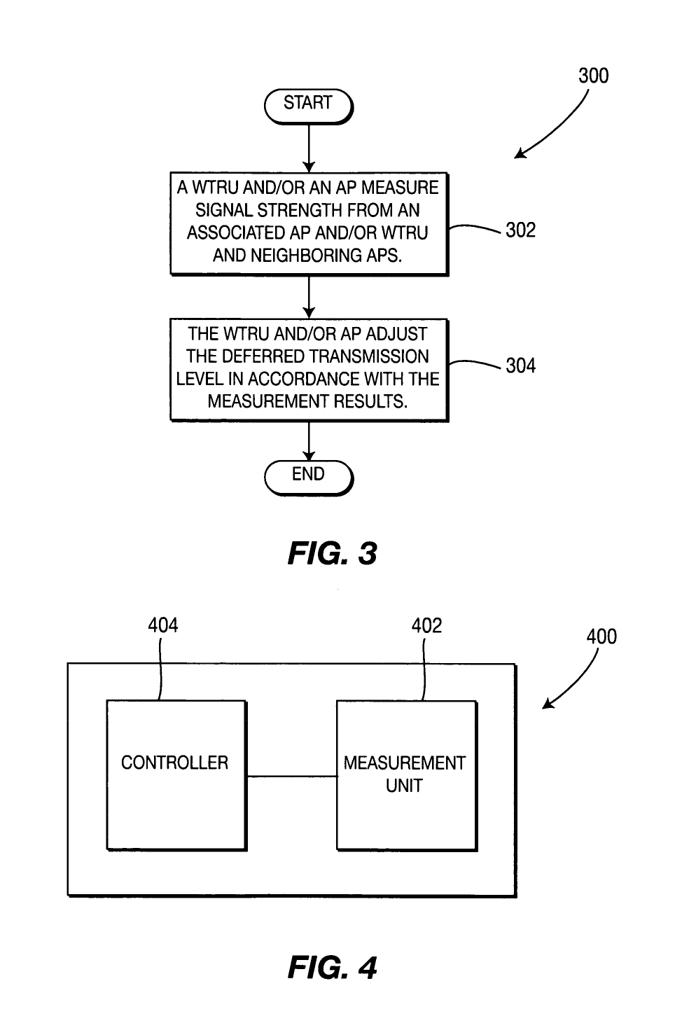

FIG. 3 is a flow diagram of a process 300 for dynamically adjusting the deferred transmission level in accordance with the present invention. A WTRU and/or an AP measure the signal strength or another parameter from an associated AP and/or WTRU and neighboring APs; either periodically or non-periodically (step 302). The WTRU and/or AP then adjust the deferred transmission level in accordance with the measurement results (step 304).

In accordance with the present invention, each device determines its optimum transmission power level based on the estimation of path losses to other co-channel devices (WTRUs or APs) belonging to neighboring BSSs. The optimum transmission power level is selected based on a metric that takes into account the probability of an unsuccessful transmission in neighboring BSSs due to the occurrence of a partial defer situation. The metric may also, optionally, take into account the probability that a no defer situation takes place.

The optimum transmission power level is sought within a range of possible transmission power levels for the device. The lowest value of this range is set so as to ensure acceptable performance for the device's communications within its own BSS and on the capability of the transmitter, whichever is higher. The highest value of the range is set either based on the capability of the transmitter or by signaling from its associated AP, if the device is a WTRU.

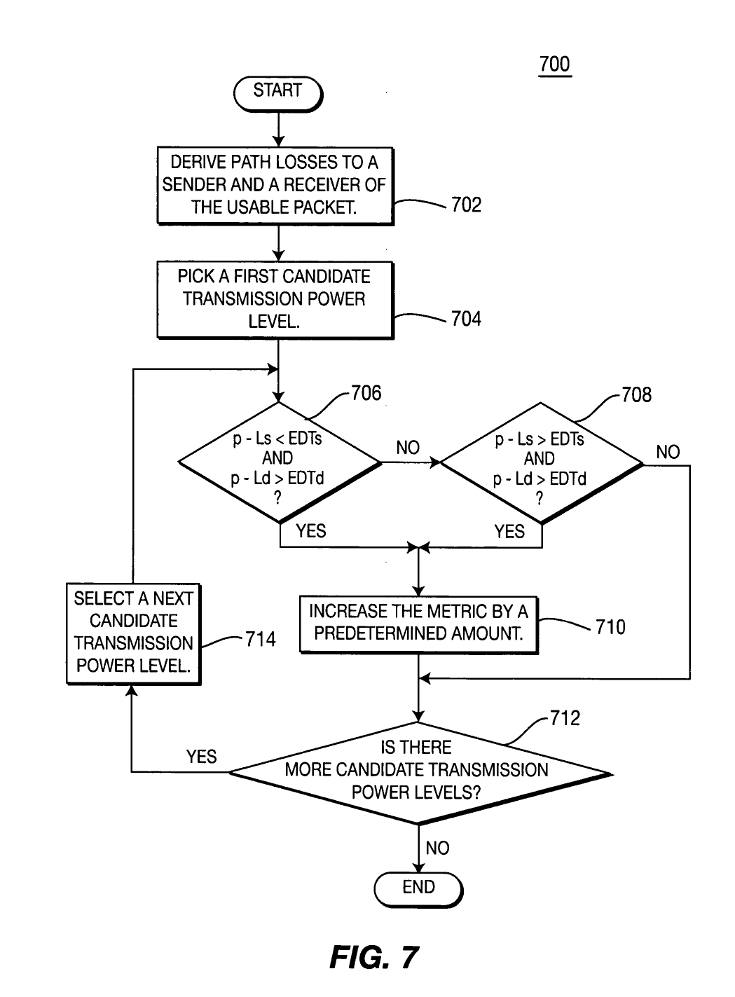

FIG. 6 is a flow diagram of a process 600 for controlling transmission power autonomously in accordance with the present invention. A device, (i.e., WTRU or AP), initializes a metric for each of a plurality of predetermined transmission power levels at an initiation of a measurement period (step 602). A plurality of candidate transmission power levels are pre-defined for the device and a metric is calculated for each of the transmission power levels. For example, the device may consider transmitting at one of the levels in a set of values between 0 and 20 dBm by a step of 1 dB, (i.e., {0, 1, 2, . . . 20 dBm}). Other sets of candidate values may be used. The device may use a finer granularity at the expense of having to perform more calculations. For each of these pre-defined transmission power levels, a metric is calculated, which will be explained in detail with reference to FIG. 7.

It is then determined whether the measurement period has expired (step 604). If the measurement period has not expired, it is further determined whether a usable packet has been received (step 606). The usable packet is a packet originated from a neighboring BSS and can be any type of packet destined to any device for any purpose as far as the following requirements are met. It must be possible to know the identity of the BSS to which the sender of the packet belongs and it must be possible to know if the sender of the packet is an AP or a WTRU. If the device that is estimating the path loss is a WTRU, it must also be possible to know the identity of the sender of the packet.

When the sender of the packet is a WTRU, a destination address of the packet should be the address of the AP serving the BSS to which the sender belongs. This address can be used as an identifier for the BSS. The device estimating the path loss can also recognize an address as the address of an AP if the device has received packets in the past that had the same address as their source address and that could be identified as a packet coming from an AP. In an IEEE 802.11 WLAN, the “From DS” field in a MAC header of the data and management types of packet can indicate if the packet sender is an AP.

Referring still to FIG. 6, if no usable packet has been received, the process 600 returns to step 604. If a usable packet has been received, the device updates the metric for every candidate transmission power levels (step 608). The update of the metric for a certain transmission power level is primarily based on evaluating the amount of capacity degradation due to partial defer situation that would take place in neighboring BSSs if the device transmits at this power level. This evaluation is performed by determining, when a packet sent by a device in a neighboring BSS is received, whether or not the sender and the receiver of the packet would be subject to the partial defer situation when the device transmits at the transmission power level. For example, referring to FIG. 1, when AP 102a receives a packet which is sent from AP 102b to WTRU 104c, AP 102a determines for each of predefined transmission power levels whether transmission at a particular transmission power level would cause a partial defer to AP 102b and WTRU 104c. If so, AP 102a increases a metric for the particular transmission power level.

After updating the metric, the process 600 returns to step 604. After expiration of the measurement period, a transmission power level with the lowest metric is selected for transmission (step 610). If there is more than one value in the candidate set of transmission power levels for which the value of the metric is minimum, the device may select any of the values. Preferably, the device selects the smallest power value among those values. This increases the probability that no defer situation takes place in neighboring BSSs.

FIG. 7 is a flow diagram of a detailed process 700 for updating a metric in process 600. A device estimates a path loss to another co-channel device (step 702). The path loss is calculated based on the power level of the received packet sent by the co-channel device as well as the known or assumed transmission power of the co-channel device. The path loss is understood as including the antenna gains of the devices.

Several different methods can be used to estimate the transmission power level of the sender of the packet. In accordance with one embodiment, the devices periodically broadcast their transmission power level to other devices. Alternatively, if a neighboring AP imposes a transmission power limit to its associated WTRUs, the device may decode beacons or other packets sent by the neighboring AP that carry this information. Alternatively, if there is no imposed transmission power limit to the WTRUs, the device may use a typical or average value of the maximum transmission power of commercially available WTRUs. Alternatively, an AP may estimate the path loss to a neighboring AP by selecting the packets sent by this AP that have been received with the largest power, if this neighboring AP intermittently transmits packets at a pre-established maximum power level.

After calculating a path loss based on the received packet, the device selects a first transmission power level among a plurality of predefined transmission power levels (step 704). The device then determines whether the selected transmission power level subtracted by the pass loss to the receiver of the packet is greater than a deferred transmission power level of the receiver and the transmission power level subtracted by the pass loss to the sender of the packet is less than a deferred transmission power level of the sender (step 706). If not, the device further determines whether the selected transmission power level subtracted by the pass loss to the sender of the packet is greater than a deferred transmission power level of the sender and the transmission power level subtracted by the pass loss to the receiver of the packet is less than a deferred transmission power level of the receiver (step 708).

The device determines that the sender and the receiver of the packet would be subject to the partial defer situation, if the device transmits at a transmission power level p (in dBm) such that:
p−Ls<EDTs and p−Ld>EDTd, or,
p−Ls>EDTs and p−Ld<EDTd
where Ls is a path loss (in dB) between the device and the sender of the packet and Ld is a path loss (in dB) between the device and the receiver of the packet. EDTₛ and EDT_{d} are the deferred transmission level in dBm of the sender and the receiver, respectively. The transmission power level p is also in dBm. The device may assume a standard value for these quantities, if the device does not know the specific values used by the sender and the receiver.

If the determinations both at steps 706 and 708 are not positive, the process 700 proceeds to step 712 to determine whether there is more candidate transmission power levels. If the determination is positive at either step 706 or 708, a metric associated with the transmission power level is increased (step 710). Next, the process 700 proceeds to step 712 to determine whether there is more candidate transmission power levels. If there if more candidate transmission power level, the next candidate transmission power level is selected at step 714 and the process 700 proceeds to step 706.

By increasing the value of the metric every time a usable packet is received, the metric is weighted according to the traffic intensity between the sender and the receiver (but regardless of its direction). This is logical since the damage to a neighboring BSS capacity caused by a partial defer situation increases with the traffic intensity between the affected devices.

Preferably, the device does not increase twice the value of the metric when the device receives both the initial packet and the ACK packet sent back by the receiver. This is to avoid overweighing the importance of a particular pair of neighboring devices with respect to other pairs of devices for which only one of the packets in an exchange can successfully be decoded. To avoid this condition and for the sake of simplicity, the device may simply restrict the usable packets to be of certain types so that only one of the packets involved in an exchange can be counted. For example, the device may restrict the usable packets to ACK packets or CTS packets. These types of packets are usually sent at a lower rate than data packets, which increases the likelihood of successful detection.

Alternatively, step 706 may be applied only to the initial packet of the exchange and step 708 may be applied only to the ACK packet of the exchange. This would more accurately weight according to the traffic intensity when there is asymmetry in the direction of the traffic between devices.

Referring back to FIG. 4, the measurement unit 402 of the apparatus 400 measures strength of received signal and the controller 404 performs the functions for autonomously adjusting transmission power level in accordance with the present invention. The controller 404 initializes a metric for each of a plurality of transmission power levels at initiation of a measurement period. If a packet originated from a neighboring BSS is received, the controller 404 updates the metric for each of the transmission power levels as explained hereinabove. The controller calculates a path loss to the sender of the packet and a path loss to the receiver of the packet and determines for each transmission power level whether the transmission power level subtracted by the path loss to the sender is greater than a deferred transmission level of the sender and the transmission power level subtracted by the path loss to the receiver is less than a deferred transmission level of the receiver or whether the transmission power level subtracted by the path loss to the receiver is greater than the deferred transmission level of the receiver and the transmission power level of the sender is less than the deferred transmission level of the sender. The controller then increases the metric of the corresponding transmission power level if the determination is positive. The controller 404 then selects a transmission power level having a smallest metric for its own BSS transmissions.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including a plurality of basic service sets (BSSs), each BSS comprising an access point (AP) and at least one wireless transmit/receive unit (WTRU) and the AP and the WTRU sense a wireless medium for a predetermined period of time before transmitting a packet and defer transmission if a detected signal level during the predetermined period of time is greater than a deferred transmission level, a method for controlling transmission power, the method comprising:
(a) initializing a metric for each of a plurality of transmission power levels at initiation of a measurement period;
(b) if a packet originated from a neighboring BSS is received, updating the metric for each of the transmission power levels, the metric being increased if it is determined that transmission at a particular transmission power level associated to the metric would cause a partial defer to a sender and a receiver of the packet; and
(c) selecting a transmission power level having a smallest metric.

2. The method of claim 1 wherein an identity of the neighboring BSS is determined by one of a source address field and a destination address field in the packet.

3. The method of claim 1 wherein whether the sender is an AP or a WTRU is determined by From DS field in the packet.

4. The method of claim 1 wherein updating the metric is performed by the steps of:
(b1) calculating a path loss to the sender of the packet and a path loss to the receiver of the packet;
(b2) determining for each transmission power level whether the transmission power level subtracted by the path loss to the sender is greater than a deferred transmission level of the sender and the transmission power level subtracted by the path loss to the receiver is less than a deferred transmission level of the receiver or whether the transmission power level subtracted by the path loss to the receiver is greater than the deferred transmission level of the receiver and the transmission power level subtracted by the path loss to the sender is less than the deferred transmission level of the sender; and
(b3) increasing the metric of the corresponding transmission power level if the determination at step (b2) is positive.

5. The method of claim 4 wherein a transmission power level of the sender to determine the path loss to the sender is obtained from information broadcast by the sender.

6. The method of claim 4 wherein a transmission power level of the sender to determine the path loss to the sender is determined by detecting a transmission power limit imposed by a neighboring AP.

7. The method of claim 4 wherein a transmission power level of the sender to determine the path loss to the sender is set to an average value of maximum power of commercially available devices.

8. The method of claim 4 wherein the sender is an AP and the path loss to the AP is determined by using a packet sent by the AP with a maximum power level.

9. The method of claim 4 wherein the path loss to the sender is determined by using an initial packet sent by the sender and the path loss to the receiver is determined by using an acknowledgement packet sent by the receiver.

10. The method of claim 4 further comprising the steps of:
each of the AP and the WTRU measuring strength of signals originated from its own BSS and neighboring BSS; and
the AP and the WTRU adjusting the deferred transmission level based upon the measurement results.

11. The method of claim 10 wherein the AP and the WTRU dynamically determines its own deferred transmission level.

12. The method of claim 10 wherein the WTRU sends the measurement results to the AP and the AP determines the deferred transmission level and sends the deferred transmission level information to other communication entities.

13. The method of claim 12 wherein the deferred transmission level information is transmitted in a beacon frame.

14. The method of claim 12 wherein the deferred transmission level information is transmitted in one of a clear-to-send frame, a request-to-send frame, a data frame and an acknowledgement (ACK) frame.

15. In a wireless communication system including a plurality of basic service sets (BSSs), each BSS comprising an access point (AP) and at least one wireless transmit/receive unit (WTRU) and the AP and the WTRU sense a wireless medium for a predetermined period of time before transmitting a packet and defer transmission if a detected signal level during the predetermined period of time is greater than a deferred transmission level, an apparatus for controlling transmission power, the apparatus comprising:
a measurement unit for measuring strength of received signal;
a controller for initializing a metric for each of a plurality of transmission power levels at an initiation of a measurement period, if a packet originated from a neighboring BSS is received, updating the metric for each of the transmission power levels, the metric being increased if it is determined that transmission at a particular transmission power level associated to the metric would cause a partial defer to a sender of the packet and a receiver of the packet and selecting a transmission power level having a smallest metric.

16. The apparatus of claim 15 wherein an identity of the neighboring BSS is determined by one of a source address field and a destination address field in the packet.

17. The apparatus of claim 15 wherein whether the sender is an AP or a WTRU is determined by From DS field in the packet.

18. The apparatus of claim 15 wherein the controller calculates a path loss to the sender of the packet and a path loss to the receiver of the packet, determines for each transmission power level whether the transmission power level subtracted by the path loss to the sender is greater than a deferred transmission level of the sender and the transmission power level subtracted by the path loss to the receiver is less than a deferred transmission level of the receiver or whether the transmission power level subtracted by the path loss to the receiver is greater than the deferred transmission level of the receiver and the transmission power level of the sender is less than the deferred transmission level of the sender and increases the metric of the corresponding transmission power level if the determination is positive.

19. The apparatus of claim 18 wherein a transmission power level of the sender for determining the path loss to the sender is obtained from information broadcast by the sender.

20. The apparatus of claim 18 wherein a transmission power level of the sender for determining the path loss to the sender is determined by detecting a transmission power limit imposed by a neighboring AP.

21. The apparatus of claim 18 wherein a transmission power level of the sender for determining the path loss to the sender is set to an average value of maximum power of commercially available devices.

22. The apparatus of claim 18 wherein the sender is an AP and the path loss to the AP is determined by using a packet sent by the AP with a maximum power level.

23. The apparatus of claim 18 wherein the path loss to the sender is determined by using an initial packet sent by the sender and the path loss to the receiver is determined by using an acknowledgement packet sent by the receiver.

24. The apparatus of claim 18 wherein the measurement unit measures strength of signals originated from own BSS and neighboring BSS, and the controller adjusts the deferred transmission level based upon the measurement results.

25. The apparatus of claim 24 wherein the AP and the WTRU dynamically determines its own deferred transmission level.

26. The apparatus of claim 24 wherein the WTRU sends the measurement results to the AP and the AP determines the deferred transmission level and sends the deferred transmission level information to other communication entities.

27. The apparatus of claim 26 wherein the deferred transmission level information is transmitted in a beacon frame.

28. The apparatus of claim 26 wherein the deferred transmission level information is transmitted in one of a clear-to-send frame, a request-to-send frame, a data frame and an acknowledgement (ACK) frame.

29. In a wireless communication system comprising a plurality of access points (APs) and stations (STAs), the APs and the STAs monitoring a communication medium and transmitting data only if an energy level detected in the medium is lower than a deferred transmission level, an AP for dynamically adjusting the deferred transmission level, comprising:
a measurement unit for measuring signal strength from an associated STA and neighboring APs;
a controller for adjusting the deferred transmission level in accordance with the measurement results; and
wherein the deferred transmission level of STAs is set via signaling through the AP.
